(19) United States
(12) Patent Application Publication
(10) Pub. No.: US 2015/0348571 A1
(43) Pub. Date: Dec. 3, 2015

(54) SPEECH DATA PROCESSING DEVICE, SPEECH DATA PROCESSING METHOD, AND SPEECH DATA PROCESSING PROGRAM

(71) Applicant: NEC Corporation, Tokyo (JP)

(72) Inventors: Takafumi KOSHINAKA, Tokyo (JP); Takayuki SUZUKI, Tokyo (JP)

(73) Assignee: NEC Corporation

(21) Appl. No.: 14/722,455

(22) Filed: May 27, 2015

(30) Foreign Application Priority Data
May 29, 2014 (JP) 2014-111108
May 26, 2015 (JP) 2015-105939

(51) Int. Cl. G10L 25/60; G10L 15/06

(52) U.S. Cl. CPC G10L 25/60; G10L 15/063; G10L 2015/0631

(57) ABSTRACT

A data processing device, method and non-transitory computer-readable storage medium are disclosed. A data processing device may include a memory storing instructions, and at least one processor configured to process the instructions to divide a first speech data into first segments based on a data structure of the first speech data, classify the first segments into first clusters through clustering, generate a first segment speech model for each of the first clusters, and calculate a similarity between the first segment speech models and a second speech data.

### CROSS-REFERENCE TO RELATED PATENT APPLICATIONS

This application is based upon and claims the benefit of priority from Japanese Patent Application No. 2014-111108, filed on May 29, 2014 and Japanese Patent Application No. 2015-105939, filed on May 26, 2015. The entire disclosures of the above-referenced applications are incorporated herein by reference.

### BACKGROUND

1. Technical Field

The present disclosure generally relates to a speech data processing device, a speech data processing method, and a speech data processing program for calculating similarities among a plurality of speech data.

2. Description of the Related Art

Recently, electronic devices having a speech recognizing function have become popular. In fact, it has become desirable to have devices that can efficiently perform speech recognition with high accuracy.

According to a related technology, an apparatus may generate a stochastic segment model using less model parameters than those in a HMM (hidden Markov model), and perform phoneme recognition by using a word model generated based on the stochastic segment model. This apparatus can improve the recognition rate of phonemes.

In another related technology, an apparatus may inform a user who uses the speech recognizing function of a cause of misrecognition, for example, with an easily intuitively human-understandable factor. This apparatus may find feature quantities for a plurality of factors of the misrecognition based on the feature quantity of input speech, and calculate a degree of deviation from a standard model regarding the feature quantity for each factor. This apparatus may detect a factor having the greatest degree of deviation, and output this as a factor of the misrecognition.

In another related technology, an apparatus may appropriately cluster similar phoneme models so as to obtain a phoneme model with high accuracy through adaptive learning pertinent to the speech recognition. In this apparatus, phoneme models may be clustered in such a manner as to satisfy a constraint that one or more phoneme models for which a larger amount of speech data for learning is available are always included in the same cluster as that of any phoneme model for which only a smaller amount of speech data for learning is available.

With respect to the speech recognizing function, a related art document may disclose details of a common speech data processing device that calculates similarity among a plurality of speech data sets (speech information). This speech data processing device may calculate similarity among plurality of speech data sets, thereby performing speaker verification to determine whether or not those speech data sets are uttered from the same speaker.

A block diagram illustrating a configuration of a related art speech data processing device 5 is illustrated in FIG. 7. As illustrated in FIG. 7, this speech data processing device 5 may include a speech data input unit 51, a segment matching unit 52, a speech model memory unit 53, a similarity calculating unit 54, a speech data memory unit 55, a frame model generating unit 56, a frame model memory unit 57, and a speech data converting unit 58. In the speech data processing device 5, input speech data 510 generated by the speech data input unit 51 by digitizing input speech 511 on the may be compared with comparison target speech data 550 stored in the speech data memory unit 55 so as to calculate a similarity between the input speech data 510 and the comparison target speech data 550. The speech data processing device 5 may operate as described below.

The frame model generating unit 56 may divide the comparison target speech data 550 stored in the speech data memory unit 55 into frames each of which has a small time period of several tens milliseconds, thereby generating a model representing statistical characteristics of these frames. As an exemplary embodiment of the frame model, a Gaussian Mixture Model (referred to as a “GMM”, hereinafter) that is an assembly of several Gaussian distribution models may be used. Based on a method such as maximum likelihood estimation, the frame model generating unit 56 may define parameters for specifying the GMM. The GMM whose parameters are all defined may be stored in the frame model memory unit 57.

The speech data converting unit 58 may calculate a similarity between each frame into which the comparison target speech data 550 is divided and each Gaussian distribution model stored in the frame model memory unit 57. The speech data converting unit 58 may convert each frame into a Gaussian distribution model having a greatest similarity. In this manner, the comparison target speech data 550 may be converted into a Gaussian distribution model series having an equivalent length thereof. The Gaussian distribution model series obtained in this manner may be referred to as a speech model in the description for FIG. 7, hereinafter. This speech model may be stored in the speech model memory unit 53.

The speech data input unit 51 may digitize the input speech 511 so as to generate the input speech data 510. The speech data input unit 51 may input this generated input speech data 510 into the segment matching unit 52.

The segment matching unit 52 may calculate a similarity between a segment partially cut out from the input speech data 510 and a segment partially cut out from the speech model stored in the speech model memory unit 53 and detect a correspondence relation therebetween. For example, it is assumed that a time length of the input speech data 510 is TD, and a time length of the speech model is TM. The segment matching unit 52 may extract every segment (t1, t2) represented by a time t1 and a time t2 that satisfy 0≦t1<t2≦TD for the input speech data 510. The segment matching unit 52 may extract every segment (t3, t4) represented by a time t3 and a time t4 that satisfy 0≦t3<t4≦TM for the speech model. The segment matching unit 52 may calculate a similarity in each pair of segments in every possible combination, and find a pair of segments whose similarity is greater and whose length is as long as possible. The segment matching unit 52 may find a correspondence relation among the segments in such a manner that every segment in the speech model corresponds to some part of the input speech data 510.

The similarity calculating unit 54 may add up the similarities of all pairs of the segments based on the correspondence relation among the segments found by the segment matching unit 52, and output this total as the similarity between the input speech data 110 and the segment speech model.

The comparison target speech data 550 and the input speech data 510 may be often used after being converted into feature vector series obtained by processing each frame. As a feature vector, a Mel-Frequency Cepstrum Coefficient (referred to as an “MFCC”, hereinafter) or the like may be utilized.

The speech data processing device 5 illustrated in FIG. 7 may be required to calculate a similarity in each pair of segments in every possible combination. If the time length of the input speech data 510 is TD, the number of segments extractable from the input speech data 510 may be on the order of the square of TD. If the time length of the speech model is TM, the number of segments extractable from this speech model may be on the order of the square of TM. Accordingly, the number of combinations for calculating the above similarity may be on the order of (square of TD)×(square of TM).

Consider, for example, that a similarity between the input speech data 510 whose time length is one minute and the speech model whose time length is one minute is calculated. In this case, the number of frames from the input speech data 510 and the speech model may be approximately 6000 if one frame is assumed to be 10 milliseconds. Hence, the number of combinations for calculating the similarity may be on the order of the 4th power of 6000, that is, on the order of 1,300,000,000. It may be difficult for the speech data processing device 5 to complete the calculation for that number of combinations within a realistic time range.

In the case of calculating a similarity between segments having values of various time lengths, segments supposed to have a low similarity therebetween sometimes may exhibit a high similarity by accident. In some instances, if noise is superimposed on the speech data, or if the time length of the data is short, such a phenomenon may frequently occur. Hence, if such a phenomenon frequently occurs, accuracy of the similarity calculated by the speech data processing device 5 may become deteriorated.

Exemplary embodiments of the present disclosure may solve one or more of the above-noted problems. For example, the exemplary embodiments may provide a technique for calculating similarities among a plurality of speech data efficiently with high accuracy.

### SUMMARY OF THE DISCLOSURE

According to a first aspect of the present disclosure, a speech processing device is disclosed. The speech processing device may include a memory storing instructions, and at least one processor configured to process the instructions to: divide a first speech data into first segments based on a data structure of the first speech data, classify the first segments into first clusters through clustering, generate a first segment speech model for each of the first clusters, and calculate a similarity between the first segment speech models and a second speech data.

An information processing method according to another aspect of the present disclosure may include dividing first speech data into first segments based on a data structure of the first speech data, classifying the first segments into first clusters through clustering, generating a first segment speech model for each of the first clusters, and calculating a similarity between the first segment speech models and second speech data.

A non-transitory computer-readable storage medium may store instructions that when executed by a computer enable the computer to implement a method. The method may include dividing first speech data into first segments based on a data structure of the first speech data, classifying the first segments into first clusters through clustering, generating a first segment speech model for each of the first clusters, and calculating a similarity between the first segment speech models and second speech data.

### BRIEF DESCRIPTION OF THE DRAWINGS

FIG. 1 is a block diagram illustrating a configuration of a speech data processing device according to a first exemplary embodiment;

FIG. 2 is a flowchart depicting operation of the speech data processing device according to the first exemplary embodiment;

FIG. 3 is a block diagram illustrating a configuration of a speech data processing device according to a second exemplary embodiment;

FIG. 4 is a block diagram illustrating a configuration of a speech data processing device according to a third exemplary embodiment;

FIG. 5 is a block diagram illustrating a configuration of a speech data processing device according to a fourth exemplary embodiment;

FIG. 6 is a block diagram illustrating a configuration of an information processing device capable of executing the speech data processing device according to each exemplary embodiment; and

FIG. 7 is a block diagram illustrating a configuration of a related art speech data processing device.

### DETAILED DESCRIPTION

In the following detailed description numerous specific details are set forth in order to provide a thorough understanding of the disclosed embodiments. It will be apparent, however, that one or more embodiments may be practiced without these specific details. In other instances, well-known structures and devices are schematically illustrated in order to simplify the drawings.

### First Exemplary Embodiment

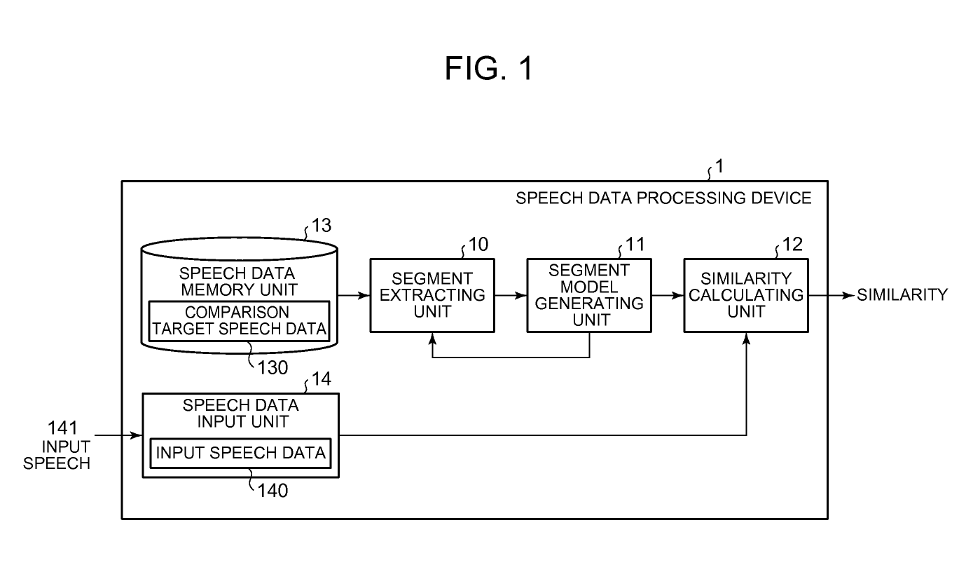

FIG. 1 is a block diagram conceptually illustrating a configuration of a speech data processing device 1 of the first exemplary embodiment.

As illustrated in FIG. 1, the speech data processing device 1 may include a segment extracting unit 10, a segment model generating unit 11, a similarity calculating unit 12, a speech data memory unit 13, and a speech data input unit 14.

The segment extracting unit 10, the segment model generating unit 11, and the similarity calculating unit 12 may be electronic circuits, or may be computer programs and processors operating in accordance with these computer programs. The speech data memory unit 13 may be an electronic device, such as a magnetic disk and an electronic disk, access-controlled by an electronic circuit, or a computer program and a processor operating in accordance with the computer program.

The speech data input unit 14 may include a speech input device, such as a microphone. The speech data input unit 14 may digitize input speech 141 uttered from a user who uses the speech data processing device 1 so as to generate input speech data 140 (second speech data). The speech data input unit 14 may input the generated input speech data 140 into the similarity calculating unit 12.

The speech data memory unit 13 may store comparison target speech data 130 (first speech data). The comparison target speech data 130 may be target speech data used for calculating a similarity with the input speech data 140.

The segment extracting unit 10 may read out the comparison target speech data 130 from the speech data memory unit 13, and divide the comparison target speech data 130 into segments to extract these segments. One of several methods may be used by the segment extracting unit 10 to divide the comparison target speech data 130 into segments.

As a first method, the segment extracting unit 10 may divide the comparison target speech data 130 at a predetermined time interval. The predetermined time interval may correspond to a time scale for a phoneme or a syllable (approximately several tens to 100 milliseconds), or may be another time interval representing a data structure of the speech. The data structure of the speech may be information indicating at least a discrete unit included in the speech. The discrete unit may include at least one of a phoneme or a syllable.

As a second method, the segment extracting unit 10 may detect a change point of a value represented by the comparison target speech data 130, and based on the amount of change per time unit regarding the value represented by the comparison target speech data 130, divide the comparison target speech data 130 at a time when the amount of change is larger than a threshold value. In some aspects, comparison target speech data 130 may be expressed as a time-sequential feature vector series (x₁, x₂, . . . , x_{T}). T may denote a time length of the comparison target speech data 130. The segment extracting unit 10 may calculate a value represented by a norm |xₜ₊₁−xₜ| that is a difference between adjacent feature vectors, where “t” may be any time that satisfies 0≦t≦T. If the value represented by the above norm is a threshold value or more, the segment extracting unit 10 may divide the comparison target speech data 130 between these adjacent feature vectors.

As a third method, the segment extracting unit 10 may divide the comparison target speech data 130 with reference to a segment model that is a predetermined normative partial speech model (segment speech model). In some aspects, the predetermined normative segment speech model may include a statistical model of time-sequential data such as HMM. The segment extracting unit 10 may calculate an optimum alignment of the HMMs for the feature vector series (x₁, x₂, . . . , x_{T}) that represents the comparison target speech data 130. In some aspects, using m (m is an integer of one or more) HMMs (λ₁, λ₂, . . . , λₘ) as the segment speech models, the segment extracting unit 10 may calculate a dividing point (t₀ (=0), t₁, . . . , tₛ₋₁, tₛ (=T)) on a temporal axis and a segment speech model series (m₁, . . . , mₛ₋₁, mₛ) such that a value calculated by a formula denoted in Formula 1 becomes maximum. The segment extracting unit 10 may calculate the above optimum alignment by using a search algorithm (e.g., one-path DP technique) on a basis of dynamic programming well-known in the speech recognition technology field. In Formula 1, P may denote a probability distribution regarding the feature vector series in the segment speech model. In Formula 1, S may denote the number of states of the segment speech model that is a statistical model of time-sequential data.

$${\sum }_{s = 1}^{S} log P ( {x}_{{t}_{s - 1} + 1} , {x}_{{t}_{s - 1} + 2} , … , {x}_{{t}_{s}} \vert {λ}_{{m}_{s}} ) \to max w . r . t \\ {t}_{1} , {t}_{2} , … , {t}_{s - 1} ; {m}_{1} , {m}_{2} , … , {m}_{s} ; S \qquad [ Formula 1 ]$$

The segment model generating unit 11 may cluster the segments divided by the segment extracting unit 10. In some aspects, the segment model generating unit 11 may integrate the segments having similar characteristics, thereby classifying the segments into one or more clusters. Further, using segments having similar characteristics included in each cluster as learning data, the segment model generating unit 11 may generate a segment speech model for each cluster. The segment speech model may be stored in a memory unit.

Any well-known clustering method may be utilized. For example, a known method may be used that calculates distance among segments and clusters represented by a formula denoted in Formula 2, using variance-covariance matrixes of the feature vectors included therein. In Formula 2, n₁ and n₂ may represent the numbers of the feature vectors included in two clusters (or segments), and n may represent a sum of n₁ and n₂. In Formula 2, Σ₁ and Σ₂ may represent variance-covariance matrixes of the feature vectors included in two clusters (or segments), and Σ may represent a variance-covariance matrix of a feature vector when two clusters (or segments) are combined. Assuming that each feature vector follows the normal distribution, an index represented by Formula 2 may indicate, in terms of a likelihood ratio, whether or not two clusters (or segments) should be integrated. The segment model generating unit 11 may integrate two clusters (or segments) into one cluster if the value represented by Formula 2 satisfies a predetermined condition.

n₁ log|Σ₁|+n₂ log|Σ₂|−n log|Σ| [Formula 2]

When the segment model generating unit 11 generates the segment speech model, the segment model generating unit 11 may apply a well-known parameter estimation method, using a statistical model of time-sequential data like an HMM as the segment speech model. In some instances, a parameter estimation method for an HMM on the basis of the maximum likelihood estimation may be the well-known Baum-Welch method. In other instances, methods based on Bayesian estimation such as variational Bayesian method or the Monte Carlo method may be utilized as the parameter estimation methods. The segment model generating unit 11 may determine the number of segment speech models, the number of states and the number of mixtures of each segment speech model (HMM) by using an existing method for model selection (such as the minimum description length principle, the Bayesian information criterion, the Akaike's information criterion, and the Bayesian posterior probability).

The segment extracting unit 10 may receive feedback from the segment model generating unit 11, and re-divide the comparison target speech data 130 into segments. In some aspects, the segment extracting unit 10 may re-divide the comparison target speech data 130 into segments with the aforementioned third method regarding the segment division, using the segment speech model previously generated by the segment model generating unit 11. The segment model generating unit 11 may generate a segment speech model using the newly divided segments. The segment extracting unit 10 and the segment model generating unit 11 may repetitively execute the operation with the feedback as described above until the division of the comparison target speech data 130 by the segment extracting unit 10 converges.

The similarity calculating unit 12 may receive the input speech data 140 from the speech data input unit 14. The similarity calculating unit 12 may receive the segment speech model from the segment model generating unit 11 or a memory unit. The similarity calculating unit 12 may calculate a similarity between the input speech data 140 and the segment speech model. In some aspects, the similarity calculating unit 12 may calculate the similarity using a formula denoted in Formula 1. In some aspects, the similarity calculating unit 12 may calculate the similarity using search algorithm based on the dynamic programming. For example, the similarity calculating unit 12 may calculate an optimum alignment of the HMMs for the feature vector series (y₁, y₂, . . . , y_{T}) that represents the input speech data 140 instead of the optimum alignment of the HMMs for the feature vector series (x₁, x₂, . . . , x_{T}) in formula 1. Exemplarily, the similarity calculating unit 12 may input the feature vector series (y₁, y₂, . . . , y_{T}) instead of the feature vector series (x₁, x₂, . . . , x_{T}) in formula 1. For example, using m (m is an integer of one or more) HMMs (λ₁, λ₂, . . . , λ_{T}) as the segment speech models from the segment model generating unit 11, the similarity calculating unit 12 may calculate a dividing point (t₀ (=0), t₁, . . . , tₛ₋₁, tₛ (=T)) on a temporal axis and a segment speech model series (m₁, . . . , mₛ₋₁, mₛ) such that a value calculated by a formula denoted in Formula 1 becomes maximum.

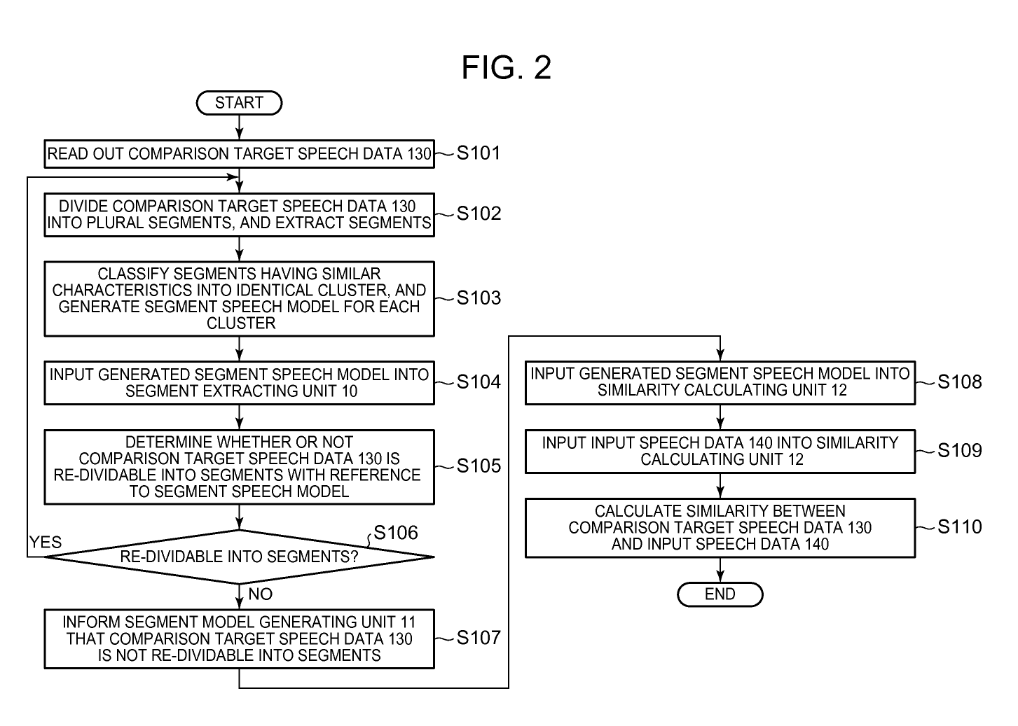

With reference to a flowchart of FIG. 2, exemplary operations (processing) of the speech data processing device 1 of the present exemplary embodiment will be described in detail below.

In step S101, the segment extracting unit 10 may read out the comparison target speech data 130 from the speech data memory unit 13. In step S102, the segment extracting unit 10 may divide the comparison target speech data 130 into a plurality of segments based on a predetermined reference, and extract these segments. In step S103, among the segments divided by the segment extracting unit 10, the segment model generating unit 11 may classify segments having similar characteristics into an identical cluster so as to generate a segment speech model for each cluster.

In step S104, the segment model generating unit 11 may input each generated segment speech model into the segment extracting unit 10. In step S105, with reference to the segment speech model input from the segment model generating unit 11, the segment extracting unit 10 may determine whether or not the comparison target speech data 130 is re-dividable into segments.

If the comparison target speech data 130 is re-dividable into segments (Yes in step S106), the processing may return to step S102. If the comparison target speech data 130 is not re-dividable into segments (No in step S106), the segment extracting unit 10 may inform the segment model generating unit 11 that the comparison target speech data 130 is not re-dividable into segments in step S107.

In step S108, the segment model generating unit 11 may input each generated segment speech model into the similarity calculating unit 12. In step S109, the speech data input unit 14 may receive the input speech 141, generate the input speech data 140 from the input speech 141, and input the generated input speech data 140 into the similarity calculating unit 12. In step S110, the similarity calculating unit 12 may calculate a similarity between the comparison target speech data 130 and the input speech data 140, and then the entire processing may be completed.

The processing executed by the speech data processing device 1 may be roughly classified into a processing set pertinent to steps S101 to S108, and a processing set pertinent to steps S109 to S110. With respect to these two processing sets, the speech data processing device 1 may execute one processing set several times while executing the other processing set once. Moreover, the order of the various steps may be changed.

The speech data processing device 1 according to the present exemplary embodiment may calculate similarities among the plurality of speech data efficiently with high accuracy. This is because the segment extracting unit 10 may divide the comparison target speech data 130 into segments, the segment model generating unit 11 may divide the data into one or more clusters by clustering these segments so as to generate the segment speech model for each cluster, and the similarity calculating unit 12 may calculate the similarity between the comparison target speech data 130 and the input speech data 140 using the above segment speech model.

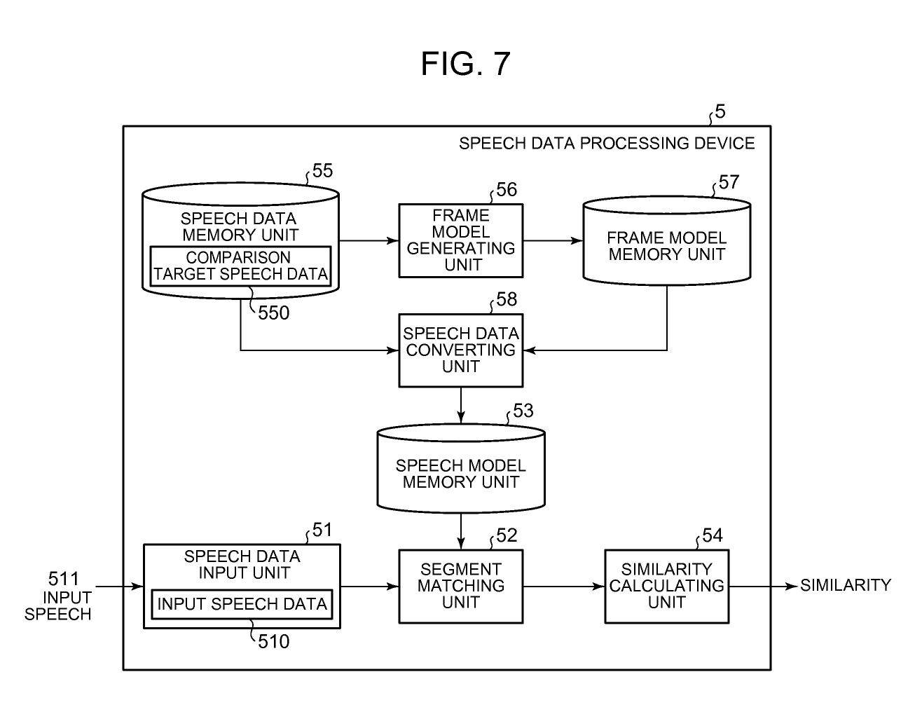

The related art speech data processing device 5 illustrated in FIG. 7 may generate the speech models based on the frames formed by dividing the comparison target speech data 550 based on a predetermined time unit, and calculate the similarity between the input speech data 510 and the speech data for comparison 550 using the speech models. The amount of calculation processed by the speech data processing device 5 may become tremendously large, as described above. If noise is superimposed on the input speech data 510, for example, the accuracy of the similarity calculated by the speech data processing device 5 may become deteriorated.

By contrast, the speech data processing device 1 according to the present exemplary embodiment may divide the comparison target speech data 130 into segments based on the speech data structure, and classify the segments having similar characteristics into the identical cluster. The speech data processing device 1 may generate the segment speech model for each cluster, and calculate the similarity between the comparison target speech data 130 and the input speech data 140 using the segment speech models. The scale of each segment speech model may become smaller, and the amount of calculation processed by the speech data processing device 1 may become significantly smaller than the amount of calculation processed by the speech data processing device 5. Accordingly, the speech data processing device 1 may efficiently calculate the similarities between a plurality of pieces of speech information.

The segment speech model generated by the speech data processing device 1 according to the present exemplary embodiment may be based on the segments divided depending on the speech data structure. Therefore, the speech data processing device 1 may calculate the similarities regarding a plurality of speech data with high accuracy.

The segment extracting unit 10 and the segment model generating unit 11 according to the present exemplary embodiment may repetitively execute the processing pertinent to the division of the comparison target speech data 130 into segments, and to the generation of the segment speech models. Accordingly, the speech data processing device 1 may generate segment speech models that achieve more efficient and accurate calculation of the above similarities.

### Second Exemplary Embodiment

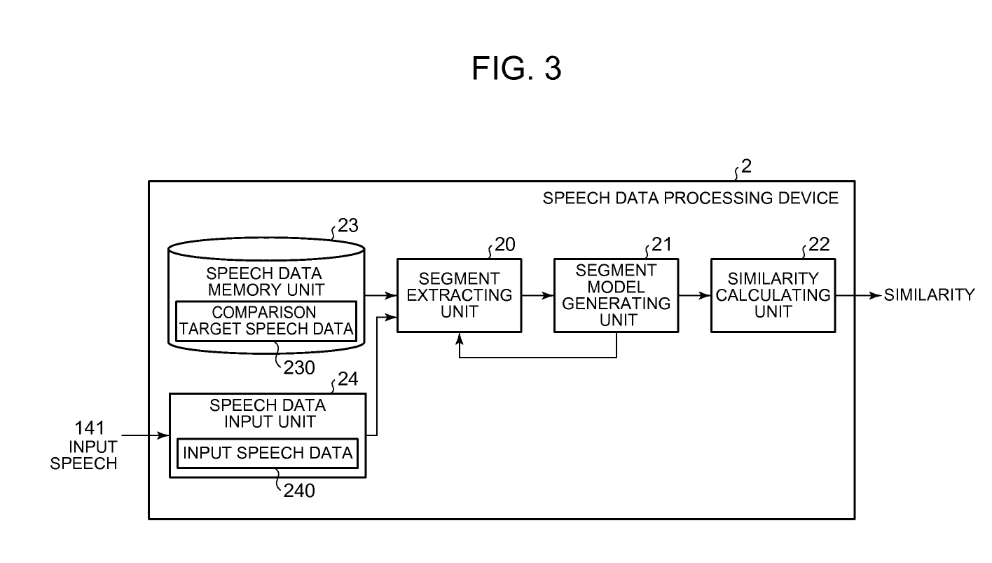

FIG. 3 is a block diagram illustrating the configuration of a speech data processing device 2 according to the second exemplary embodiment.

As illustrated in FIG. 3, the speech data processing device 2 may include a segment extracting unit 20, a segment model generating unit 21, a similarity calculating unit 22, a speech data memory unit 23, and a speech data input unit 24. As will be apparent, the configuration of the elements of speech data processing device 2 may be similar to the configuration of the elements of the speech data processing device 1.

The speech data input unit 24 may digitize input speech 241 so as to generate input speech data 240, and input the generated input speech data 240 into the segment extracting unit 20.

The segment extracting unit 20 may receive comparison target speech data 230 stored in the speech data memory unit 23 and the input speech data 240, and divide both these speech data into segments to extract these segments. The segment extracting unit 20 may divide these speech data into segments in the same manner as that executed by the segment extracting unit 10 according to the first exemplary embodiment. For example, the segment extracting unit 20 may calculate an optimum alignment of the HMMs for the feature vector series (y₁, y₂, . . . , y_{T}) that represents the input speech data 240 instead of the optimum alignment of the HMMs for the feature vector series (x₁, x₂, . . . , x_{T}) in formula 1. The segment extracting unit 20 may divide the input speech data 240 into the segments based on the optimum alignment of the HMMs for the feature vector series (y₁, y₂, . . . , y_{T}).

The segment model generating unit 21 may cluster the segments divided by the segment extracting unit 20 to classify the segments into one or more clusters. The segment model generating unit 21 may generate a segment speech model for each cluster. The segment speech model may be stored in a memory. The segment model generating unit 21 may generate the segment speech models for the input speech data 240 in addition to generating the segment speech models for the comparison target speech data 230. The segment model generating unit 21 may generate the segment speech models for these speech data in the same manner as that executed by the segment model generating unit 11 according to the first exemplary embodiment.

The segment extracting unit 20 and the segment model generating unit 21 may execute repetitive processing in the same manner as that executed by the segment extracting unit 10 and the segment model generating unit 20 according to the first exemplary embodiment.

The similarity calculating unit 22 may receive the comparison target speech data 230, the input speech data 240, and the segment speech models for these speech data from the segment model generating unit 21. The similarity calculating unit 22 may calculate a similarity between the comparison target speech data 230 and the input speech data 240 based on these pieces of the information. Exemplarily, the similarity calculating unit 22 may calculate the above similarity using a formula “L-L₁-L₂” denoted in Formula 3.

In the formula denoted in Formula 3, L₁ may represent a similarity between a segment speech model λm⁽¹⁾ generated by using a feature vector series (x₁, x₂, . . . , x_{T}) corresponding to the comparison target speech data 230. In the formula denoted in Formula 3, L₂ may represent a similarity between a segment speech model λₘ⁽²⁾ generated by using a feature vector series (y₁, y₂, . . . , y_{T}) corresponding to the input speech data 240. In the formula denoted in Formula 3, L may represent similarities between a segment speech model λₘ generated by using feature vector series corresponding to the comparison target speech data 230 and the input speech data 240. These similarities may represent whether or not the comparison target speech data 230 and the input speech data 240 arise from an identical probability distribution in terms of a logarithm likelihood ratio.

$$L - {L}_{1} - {L}_{2} \\ L = {max}_{{t}_{s} , {m}_{s} , {S}_{1}} {\sum }_{s = 1}^{{S}_{1}} log P ( {x}_{{t}_{s - 1} + 1} , {x}_{{t}_{s - 1} + 2} , … , {x}_{{t}_{s}} \vert {λ}_{{m}_{s}} ) + {max}_{{t}_{s} , {m}_{s} , {S}_{2}} {\sum }_{s = 1}^{{S}_{2}} log P ( {y}_{{t}_{s - 1} + 1} , {y}_{{t}_{s - 1} + 2} , … , {y}_{{t}_{s}} \vert {λ}_{{m}_{s}} ) \\ {L}_{1} = {max}_{{t}_{s} , {m}_{s} , {S}_{1}} {\sum }_{s = 1}^{{S}_{1}} log P ( {x}_{{t}_{s - 1} + 1} , {x}_{{t}_{s - 1} + 2} , … , {x}_{{t}_{s}} \vert {λ}_{{m}_{s}}^{( 1 )} ) \\ {L}_{2} = {max}_{{t}_{s} , {m}_{s} , {S}_{2}} {\sum }_{s = 1}^{{S}_{2}} log P ( {y}_{{t}_{s - 1} + 1} , {y}_{{t}_{s - 1} + 2} , … , {y}_{{t}_{s}} \vert {λ}_{{m}_{s}}^{( 2 )} ) \qquad [ Formula 3 ]$$

The speech data processing device 2 according to the present exemplary embodiment may calculate similarities among a plurality of speech data efficiently with high accuracy. This is because the segment extracting unit 20 may divide the comparison target speech data 230 and the input speech data 240 into segments, the segment model generating unit 21 may divide the data into one or more clusters by clustering these segments so as to generate the segment speech model for each cluster, and the similarity calculating unit 22 may calculate the similarity between the comparison target speech data 230 and the input speech data 240 using the segment speech models.

The speech data processing device 2 according to the present exemplary embodiment may execute the division into segments and generate the segment speech models for both the input speech data 240 and the comparison target speech data 230. Accordingly, the speech data processing device 2 may directly compare respective common portions between the comparison target speech data 230 and the input speech data 240 by using the respective segment speech models generated from both speech data. Hence, the speech data processing device 2 may calculate the above similarity with higher accuracy.

### Third Exemplary Embodiment

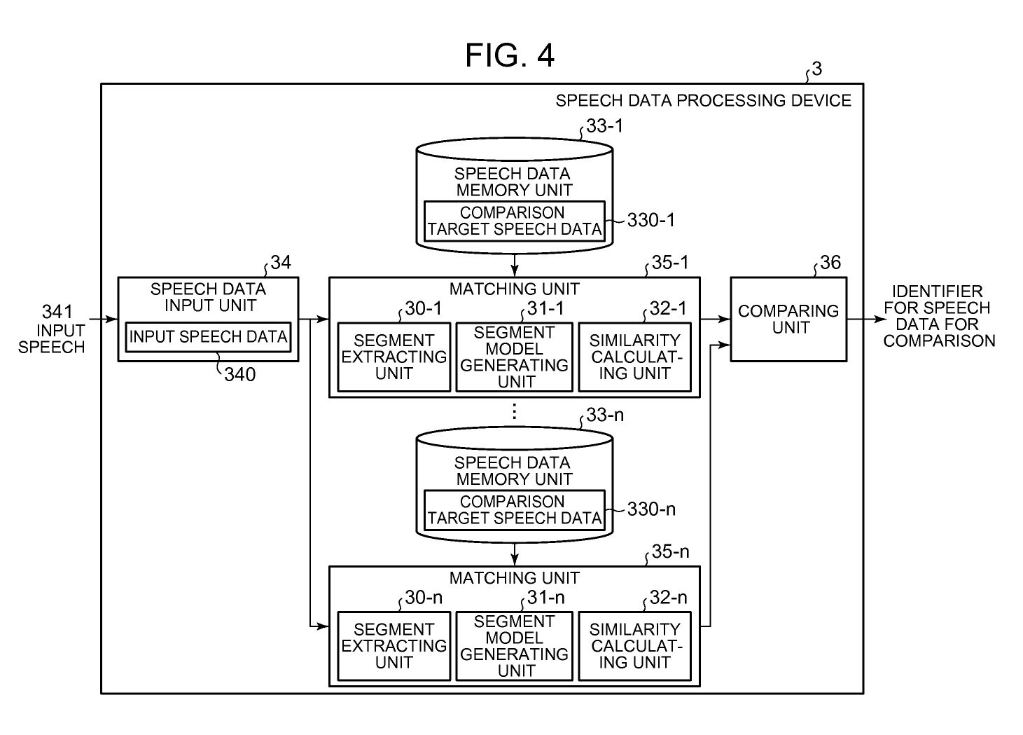

FIG. 4 is a block diagram illustrating the configuration of a speech data processing device 3 according to the third exemplary embodiment. The speech data processing device 3 according to the present exemplary embodiment may be a processing device for determining to which speech data among a plurality of comparison target speech data a speech uttered from a user is similar.

As illustrated in FIG. 4, the speech data processing device 3 may include n (n is an integer of two or more) speech data memory units 33-1 to 33-n, a speech data input unit 34, n matching units 35-1 to 35-n, and a comparing unit 36.

The speech data input unit 34 may digitize input speech 341 to generate input speech data 340, and input the generated input speech data 340 into the matching units 35-1 to 35-n.

The matching units 35-1 to 35-n may include respective segment extracting units 30-1 to 30-n, respective segment model generating units 31-1 to 31-n, and respective similarity calculating units 32-1 to 32-n. Each of the segment extracting units 30-1 to 30-n may execute similar processing as segment extracting unit 10 or segment extracting unit 20. Each of the segment model generating units 31-1 to 31-n may execute similar processing as the segment model generating unit 11 or the segment model generating unit 21. Each of the similarity calculating units 32-1 to 32-n may execute similar processing as the similarity calculating unit 12 or the similarity calculating unit 22.

The matching units 35-1 to 35-n may obtain respective comparison target speech data 330-1 to 330-n from the respective speech data memory units 33-1 to 33-n. Each of the matching units 35-1 to 35-n may obtain the input speech data 340 from the speech data input unit 34. Each of the matching units 35-1 to 35-n may calculate a similarity between each of the comparison target speech data 330-1 to 330-n and the input speech data 340, and output the calculated similarity together with an identifier for identifying each of the comparison target speech data 330-1 to 330-n to the comparing unit 36.

The comparing unit 36 may compare the similarity values between the respective comparison target speech data 330-1 to 330-n, and the input speech data 340. The comparing unit 36 may find an identifier for identifying the comparison target speech data corresponding to a similarity whose value is highest, and output this identifier.

The speech data processing device 3 according to the present exemplary embodiment may be capable of calculating similarities among the plurality of speech data efficiently with high accuracy. This is because each of the segment extracting units 30-1 to 30-n may divide each of the comparison target speech data 330-1 to 330-n into segments, and each of the segment model generating units 31-1 to 31-n may cluster the segments, thereby dividing the speech data into one or more clusters so as to generate a segment speech model for each cluster, and each of the similarity calculating units 32-1 to 32-n may calculate a similarity between each of the comparison target speech data 330-1 to 330-n and the input speech data 340 using the above segment speech models.

The speech data processing device 3 according to the present exemplary embodiment may calculate similarities between the respective comparison target speech data 330-1 to 330-n and the input speech data 340, and output an identifier for identifying the comparison target speech data having the similarity whose value is highest. Accordingly, the speech data processing device 3 may perform speech recognition for determining whether or not the input speech 341 matches any of the plurality of comparison target speech data.

### Fourth Exemplary Embodiment

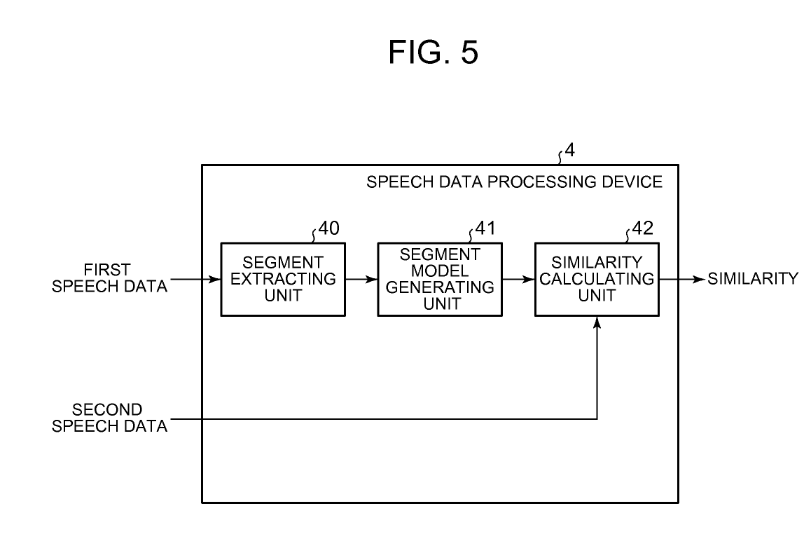

FIG. 5 is a block diagram illustrating the configuration of a speech data processing device 4 according to the fourth exemplary embodiment.

The speech data processing device 4 of the present exemplary embodiment may include a segment extracting unit 40, a segment model generating unit 41, and a similarity calculating unit 42.

The segment extracting unit 40 may divide first speech data based on a data structure of the speech data, and extract segments thereof.

The segment model generating unit 41 may classify these segments into clusters through clustering, and generate a segment model for each cluster.

The similarity calculating unit 42 may use the segment models and second speech data to calculate a similarity between the first speech data and the second speech data.

The speech data processing device 4 according to the present exemplary embodiment may be capable of calculating similarities regarding the plurality of speech data efficiently with high accuracy. This is because the segment extracting unit 40 may divide the first speech information into segments, the segment model generating unit 41 may cluster these segments, thereby dividing the above information into one or more clusters so as to generate a segment speech model for each cluster, and the similarity calculating unit 42 may calculate a similarity between the first speech information and the second speech information using the above segment speech models.

(Example of Hardware Configuration)

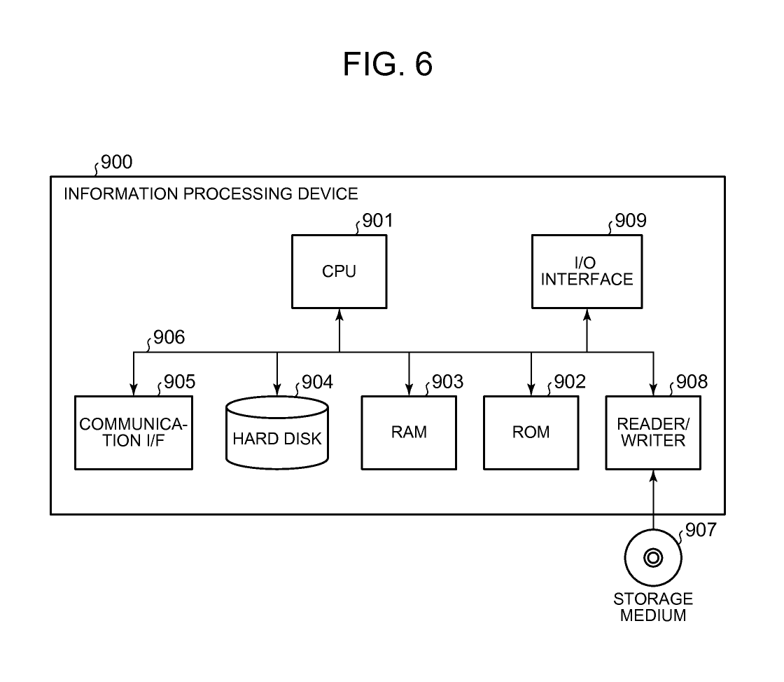

In the embodiments as described above, each unit illustrated in FIG. 1, and in FIGS. 3 to 5 may be realized by using dedicated HW (electronic circuit). Exemplarily, the segment extracting units 10, 20, 30-1 to 30-n, and 40, the segment model generating units 11, 21, 31-1 to 31-n, and 41, and the similarity calculating units 12, 22, 32-1 to 32-n, and 42 may represent a functional (processing) unit of a software program (software module). The sectioning of the respective units illustrated in these drawings may indicate a configuration for convenience of explanation, and in an actual implementation, various configurations may be considered. An example of the hardware environment in which the above exemplary embodiments may be executed will be described with reference to FIG. 6.

FIG. 6 is a drawing exemplarily explaining a configuration of an information processing device 900 (computer) configured to execute the speech data processing device according to each of the above exemplary embodiments.

The information processing device 900 illustrated in FIG. 6 may be a computer including a CPU (Central Processing Unit) 901, a ROM (Read Only Memory) 902, a RAM (Random Access Memory) 903, a hard disk 904 (storage unit), a communication interface 905 (interface: referred to as an “I/F”, hereinafter) for communicating with external devices, a reader/writer 908 that can read and write data stored in a storage medium 907, such as a CD-ROM (Compact Disc Read Only Memory), and an input-output interface 909, where these elements are connected via a bus 906 (communication line).

The exemplary embodiments as described above can be achieved by providing the information processing device 900 illustrated in FIG. 6 with the segment extracting units 10, 20, 30-1 to 30-n, and 40, the segment model generating units 11, 21, 31-1 to 31-n, and 41, and the similarity calculating units 12, 22, 32-1 to 32-n, and 42 in the block diagrams (FIG. 1, and FIGS. 3 to 5) referred to in the description of the embodiments, or a computer program that can realize the function of the flowchart (FIG. 2), and thereafter, reading out this computer program onto the CPU 901 that is the above described hardware so as to interpret and execute the program. The computer program provided in the above processing device may be stored in a volatile storage memory (RAM 903) or a nonvolatile storage device such as the hard disk 904 that is readable and writable.

In some aspects, for providing or installing the computer program(s) into the above described hardware, well known procedures may be employed, such as a method of installing the computer program into the processing device via various storage media 907 like a CD-ROM, and a method of externally downloading the computer program through a communication medium such as the Internet. In some instances, it may be considered that each of the exemplary embodiments is configured by code constituting the above described computer program, or by the storage medium 907 where these codes may be stored.

It will be apparent to those skilled in the art that various modifications and variations can be made to the disclosed embodiments. Other embodiments will be apparent to those skilled in the art from consideration of the specification and practice of the disclosed embodiments. It is intended that the specification and examples be considered as exemplary only, with a true scope being indicated by the following claims.

The present disclosure may be applicable to a speaker recognizing apparatus for identifying a speaker of an input speech by comparing the input speech with speeches of a plurality of speakers that are registered, and to a speaker verifying apparatus for determining whether or not an input speech is a speech of a particular speaker who is registered, and the like. The present disclosure may also be applicable to an emotion recognizing apparatus for estimating a state of emotion or the like of a speaker and detecting change in emotion of the speaker, based on the speech, and to an apparatus for estimating characteristics (such as gender, age, personality, and physical diseases) of a speaker based on the speech. It will be apparent that the above applications are exemplary and not intended to be limiting. Several other applications will be apparent to a person of ordinary skill.

1. A speech data processing device comprising:
a memory storing instructions; and
at least one processor configured to process the instructions to:
divide a first speech data into first segments based on a data structure of the first speech data,
classify the first segments into first clusters through clustering,
generate a first segment speech model for each of the first clusters, and
calculate a similarity between the first segment speech models and a second speech data.

2. The speech data processing device according to claim 1, wherein the at least one processor is configured to process the instructions to:
divide the first speech data into second segments using the generated first segment speech models, and
generate second segment speech models for the second segments.

3. The speech data processing device according to claim 1, wherein the at least one processor is configured to process the instructions to:
calculate an optimum alignment for the second speech data, and
calculate a similarity between the first speech data and the second speech data based on the optimum alignment.

4. The speech data processing device according to claim 1, wherein the at least one processor is configured to process the instructions to:
divide the first speech data into the first segments by calculating an optimum alignment for the first speech data.

5. The speech data processing device according to claim 1, wherein the at least one processor is configured to process the instructions to:
divide the first speech data into the first segments by dividing the first speech data at predetermined time intervals.

6. The speech data processing device according to claim 1, wherein the at least one processor is configured to process the instructions to:
divide the first speech data into the first segments by detecting a change point of a value represented by the first speech data.

7. The speech data processing device according to claim 1, wherein the at least one processor is configured to process the instructions to:
calculate a distance among the first segments based on variance-covariance matrices of feature vectors included in the first segments, and
execute clustering based on the calculated distances.

8. The speech data processing device according to claim 1, wherein the at least one processor is configured to process the instructions to:
divide the second speech data into second segments,
generate second segment speech models of second clusters of the second segments, and
calculate a similarity between the first speech data and the second speech data using the first and second segment speech models.

9. The speech data processing device according to claim 8, wherein the at least one processor is configured to process the instructions to:
divide the second speech data into the second segments and the first speech data into the first segments by calculating an optimum alignment for the first speech data and the second speech data.

10. The speech data processing device according to claim 1, wherein the at least one processor is configured to process the instructions to:
calculate a similarity between each of a plurality of the first speech data and the second speech data, and
output an identifier for the first speech data based on the calculated similarity.

11. A speech data processing method comprising:
dividing first speech data into first segments based on a data structure of the first speech data;
classifying the first segments into first clusters through clustering;
generating a first segment speech model for each of the first clusters; and
calculating a similarity between the first segment speech models and second speech data.

12. The speech data processing method according to claim 11, further comprising:
dividing the first speech data into second segments using the generated first segment speech models, and
generating second segment speech models for the second segments.

13. The speech data processing method according to claim 11, further comprising:
calculating an optimum alignment for the second speech data, and
calculating a similarity between the first speech data and the second speech data based on the optimum alignment.

14. The speech data processing method according to claim 11, further comprising:
dividing the first speech data into the first segments by calculating an optimum alignment for the first speech data.

15. The speech data processing method according to claim 11, further comprising:
dividing the second speech data into second segments,
generating second segment speech models of second clusters of the second segments, and
calculating a similarity between the first speech data and the second speech data using the first and second segment speech models.

16. A non-transitory computer-readable storage medium storing instructions that when executed by a computer enable the computer to implement a method comprising:
dividing first speech data into first segments based on a data structure of the first speech data;
classifying the first segments into first clusters through clustering;
generating a first segment speech model for each of the first clusters; and
calculating a similarity between the first segment speech models and second speech data.

17. The non-transitory computer-readable storage medium according to claim 16, wherein the method further comprises:
dividing the first speech data into second segments using the generated first segment speech models, and
generating second segment speech models for the second segments.

18. The non-transitory computer-readable storage medium according to claim 16, wherein the method further comprises:
calculating an optimum alignment for the second speech data, and
calculating a similarity between the first speech data and the second speech data based on the optimum alignment.

19. The non-transitory computer-readable storage medium according to claim 16, wherein the method further comprises:
dividing the first speech data into the first segments by calculating an optimum alignment for the first speech data.

20. The non-transitory computer-readable storage medium according to claim 16, wherein the method further comprises:
dividing the second speech data into second segments,
generating second segment speech models of second clusters of the second segments, and
calculating a similarity between the first speech data and the second speech data using the first and second segment speech models.
